(19) United States
(12) Patent Application Publication
(10) Pub. No.: US 2026/0217202 A1
(43) Pub. Date: Jul. 30, 2026

(54) VEHICULAR COVER MEMBER

(71) Applicants: TOYOTA BOSHOKU KABUSHIKI KAISHA, Aichi-ken (JP); TOYOTA JIDOSHA KABUSHIKI KAISHA, Aichi-ken (JP)

(72) Inventors: Nobuhiko MATSUBARA, Aichi-ken (JP); Isao SHINAGAWA, Aichi-ken (JP)

(73) Assignees: TOYOTA BOSHOKU KABUSHIKI KAISHA, Aichi-ken (JP); TOYOTA JIDOSHA KABUSHIKI KAISHA, Aichi-ken (JP)

(21) Appl. No.: 19/447,625

(22) Filed: Jan. 13, 2026

(30) Foreign Application Priority Data
Jan. 28, 2025 (JP) 2025-011944
Nov. 27, 2025 (JP) 2025-205654

(51) Int. Cl. B60R 13/01; B60R 5/04; B62D 25/08

(52) U.S. Cl. CPC B60R 13/011; B60R 5/044; B62D 25/087

(57) ABSTRACT

A vehicular cover member covering an object from above includes a first cover portion and a second cover portion. The first cover portion includes a first body portion having a first side edge, a downward extending portion extending downward from the first side edge, an outward extending portion extending from the downward extending portion, a wall extending upward from the outward extending portion, and a recess portion including an outlet so as not to overlap the object. The second cover portion includes a second body portion having a second side edge and is disposed next to the first cover portion and overlaps the outward extending portion of the first cover portion from above. A border of the first body portion and the second body portion defined by the first side edge and the second side edge overlaps the object.

### CROSS REFERENCE TO RELATED APPLICATION

This application claims priority from Japanese Patent Application No. 2025-11944 filed on January 28, 2025 and Japanese Patent Application No. 2025-205654 filed on November 27, 2025. The entire contents of the priority applications are incorporated herein by reference.

### TECHNICAL FIELD

The technology described herein relates to a vehicular cover member.

### BACKGROUND

An electric device that is disposed in a vehicular luggage compartment may be waterproofed with a structure described below. For instance, an electric device is disposed below a floor board, which is configured as a floor of the luggage compartment, and is disposed in a tire pan in the luggage compartment. A drain valve is disposed in the tire pan for draining liquid such as water infiltrating into the luggage compartment. The electric device is disposed above a drainage line, which connects a periphery of the tire pan and the drain valve, with respect to a vertical direction.

### SUMMARY

A cover member that covers an object such as an electric device may be configured by joining multiple plate members. With the joint portion (a border portion) of the multiple plate members being disposed above the object, liquid may infiltrate via the joint portion (the border) and may fall on the object and the object may be adversely affected. Therefore, protection measures need to be undertaken such that liquid infiltrating via the joint portion does not reach the object.

The technology described herein was made in view of the foregoing circumstances. An object is to provide a vehicular cover member with which liquid infiltrating via a border portion of plate members of the cover member is less likely to directly drop on an object.

The technology described herein is related to a vehicular cover member covering an object from above. The vehicular cover member includes a first cover portion and a second cover portion. The first cover portion includes a first body portion that has a plate shape and a first side edge, a downward extending portion that extends downward from the first side edge, an outward extending portion that extends outward from an extending end of the downward extending portion, a wall that extends upward from an extending end of the outward extending portion and extends along and opposite the downward extending portion, and a recess portion that is defined by the downward extending portion, the outward extending portion, and the wall, the recess portion including an outlet so as not to overlap the object. The second cover portion includes a second body portion that has a plate shape and a second side edge. The second cover portion is disposed next to the first cover portion such that the first body portion is continuous to the second body portion and overlaps the outward extending portion of the first cover portion from above. A border of the first body portion and the second body portion defined by the first side edge and the second side edge overlaps the object.

### BRIEF DESCRIPTION OF THE DRAWINGS

FIG. 1 is a perspective view of a cargo space of a vehicle seen from a rear left side.

FIG. 2 is a cross-sectional view of a rear section of the vehicle.

FIG. 3 is a plan view of a package tray of one embodiment.

FIG. 4 is a perspective view of a front portion of the package tray seen from a rear side.

FIG. 5 is a cross-sectional view of a portion of the package tray along line V-V in FIG. 3.

FIG. 6 is a cross-sectional view of a portion of the package tray along line VI-VI in FIG. 3.

FIG. 7 is an enlarged perspective view of a portion of a first cover portion.

FIG. 8 is an enlarged perspective view of a portion of the first cover portion.

FIG. 9 is a cross-sectional view of a portion of the package tray along line IX-IX in FIG. 3.

FIG. 10 is a cross-sectional view of a portion of the package tray along line X-X in FIG. 3.

### DETAILED DESCRIPTION

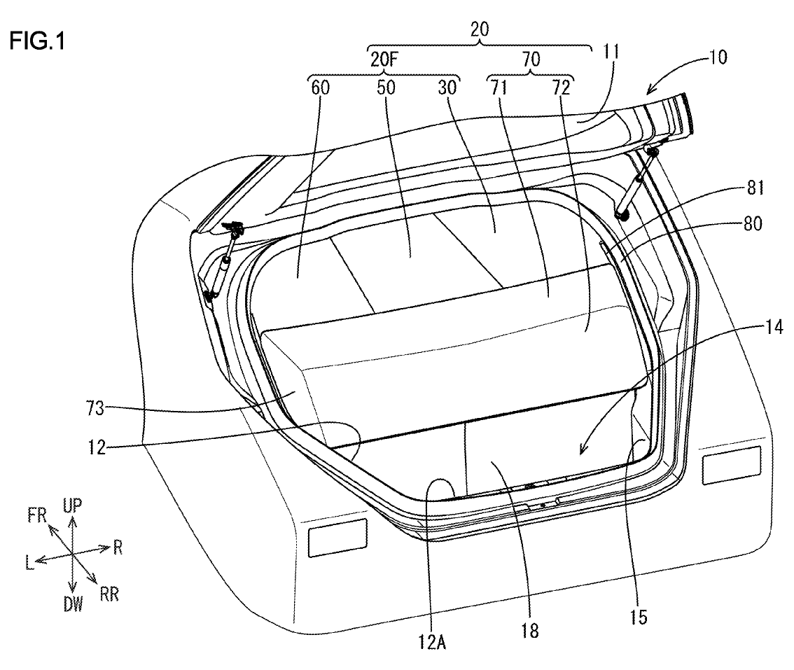

A package tray 20 will be described with reference to FIGS. 1 to 10 as one embodiment of a vehicular cover member. The package tray 20 of this embodiment is disposed between a luggage compartment 14 that is in a rear section of a vehicle 10 and a seat back 13 of a seat. In the drawings, arrows FR and RR point a front side and a rear side of the vehicle 10 with respect to a vehicular front-rear direction, respectively, arrows UP and DW point an upper side and a lower side, respectively, and arrows R and L point a right side and a left side of the vehicle 10 with respect to a vehicular width direction, respectively.

FIG. 1 is a perspective view of the vehicle 10 seen from a rear left side. The vehicle 10 is a 2-seater coupe and includes two doors. The vehicle 10 includes the luggage compartment 14 in the rear section. With a rear door 11 of a hatchback type being open, the luggage compartment 14 can be accessed through a rear opening 12 of the vehicle 10.

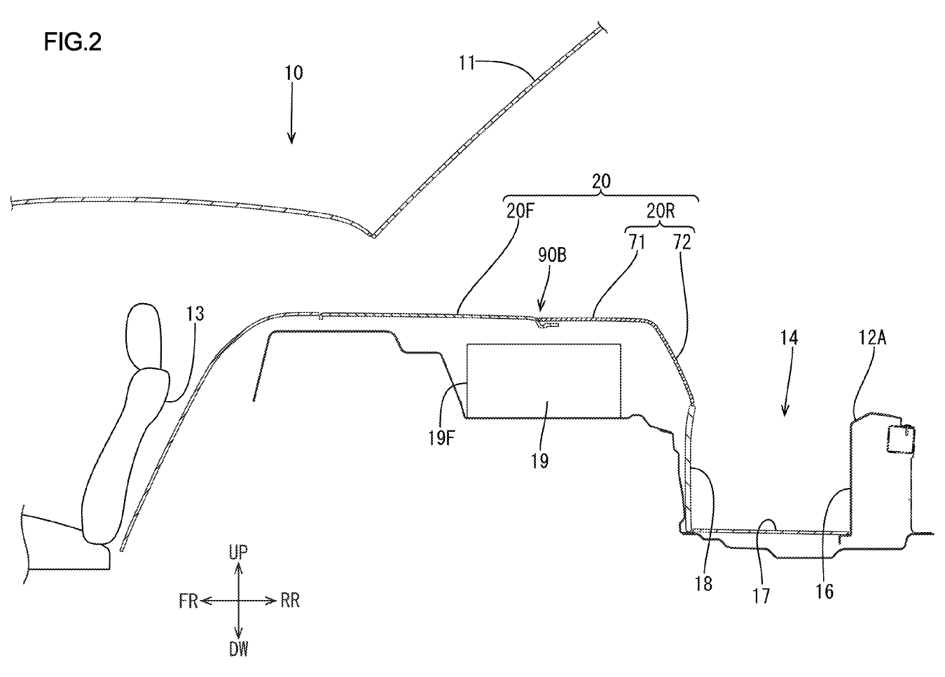

The luggage compartment 14 includes deck side trims 15, a finisher 16, a deck board 17, and a luggage front trim 18. The luggage compartment 14 has a space surrounded by the deck side trims 15, the finisher 16, the deck board 17, and the luggage front trim 18. The deck side trims 15 are configured as right and left side surfaces and portions of a rear surface of the luggage compartment 14. The finisher 16 is disposed between the right and left deck side trims 15 on the rear side and configured as a middle portion of the rear surface. The deck board 17 is configured as a floor surface of the luggage compartment 14. The luggage front trim 18 is configured as a front surface of the luggage compartment 14. As illustrated in FIG. 2, a battery 19 (one example of an object), which is a vehicular electric component, is disposed in front of the luggage compartment 14. The battery 19 is a component installed in a vehicle (a vehicular installation component, vehicular component). The battery 19 is usually disposed under a rear seat; however, in the vehicle 10 of a 2-seater coupe, the battery 19 may be disposed between the seat back 13 of the front seat and the luggage compartment 14. In this embodiment, the battery 19 is disposed between the seat back 13 of the front seat and the luggage compartment 14 and on a same level as a lower opening edge 12A of the rear opening 12 of the vehicle 10. The lower opening edge 12A is an upper edge of the finisher 16 and a lowest portion of the opening edge of the rear opening 12. The battery 19 is covered by the package tray 20. The package tray 20 is upper than the floor surface (the deck board 17) of the luggage compartment 14 and closer to a ceiling of the vehicle 10.

### Package Tray 20

The package tray 20 of this embodiment is obtained by joining plate members together. Specifically, as illustrated in FIGS. 1 to 3, the package tray 20 includes a first cover portion 30, a second cover portion 50, a third cover portion 60, a fourth cover portion 70 (one example of a rear cover portion) that are joined together. The first cover portion 30, the second cover portion 50, and the third cover portion 60 are arranged in the vehicular width direction with plate surfaces facing upward and downward. The first cover portion 30, the second cover portion 50, and the third cover portion 60 are configured as a front section 20F of the package tray 20. The fourth cover portion 70 is disposed on a rear side of the first cover portion 30, the second cover portion 50, and the third cover portion 60 and extends in the vehicular width direction from the first cover portion 30 to the third cover portion 60. The fourth cover portion 70 is configured as a rear section 20R of the package tray 20.

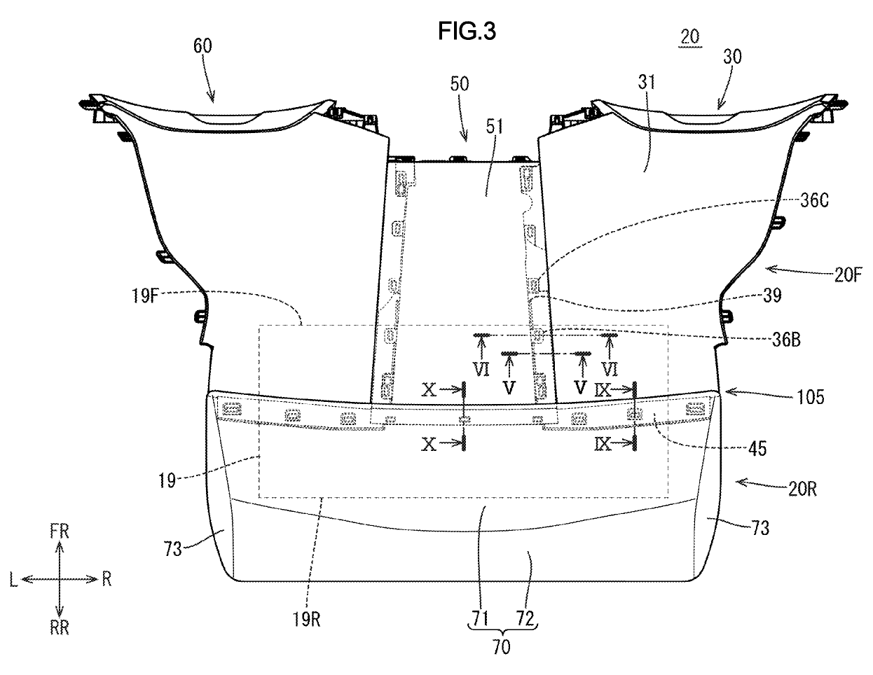

FIG. 3 is a plan view of the package tray 20. The second cover portion 50 that is a middle portion of the front section 20F of the package tray 20 is a rectangular plate member elongated in the front-rear direction. The first cover portion 30 and the third cover portion 60 on the right side and left side of the second cover portion 50, respectively, are trapezoidal plate members that increases in width as it extends frontward. As illustrated in FIGS. 1 and 2, the fourth cover portion 70 is bent such that a rear portion extends obliquely downward. The lower edge (a rear edge) of the fourth cover portion 70 is in contact with (continuous to) an upper edge of the luggage front trim 18 of the luggage compartment 14.

The coupe type vehicle 10 of this embodiment is widest in a middle section with respect to the front-rear direction and becomes narrower toward the rear section. Therefore, as illustrated in FIG. 3, the package tray 20 has a trapezoidal plan view shape and the front section 20F is wider than the rear section 20R. As illustrated in FIG. 2, the package tray 20 of this embodiment is disposed close to the ceiling of the vehicular compartment. Namely, the package tray 20 is disposed closer to the ceiling than the deck board 17 and the luggage front trim 18 of the luggage compartment 14. The rear section 20R of the package tray 20 is bent obliquely downward so as to be connected to the luggage front trim 18 that is disposed lower than the package tray 20. With such a configuration, the package tray 20 has a certain height dimension. If the entire package tray is formed from one plate member, the package tray is not put in and taken out through the rear opening 12 of the vehicle 10 easily when attaching and detaching the package tray 20 to and from the luggage compartment 14 for maintenance of the battery 19, for instance. Or the package tray cannot be put in and taken out through the rear opening 12. In this respect, the package tray 20 of this embodiment is divided into four components and therefore, the package tray 20 is put in and taken out through the rear opening 12 easily.

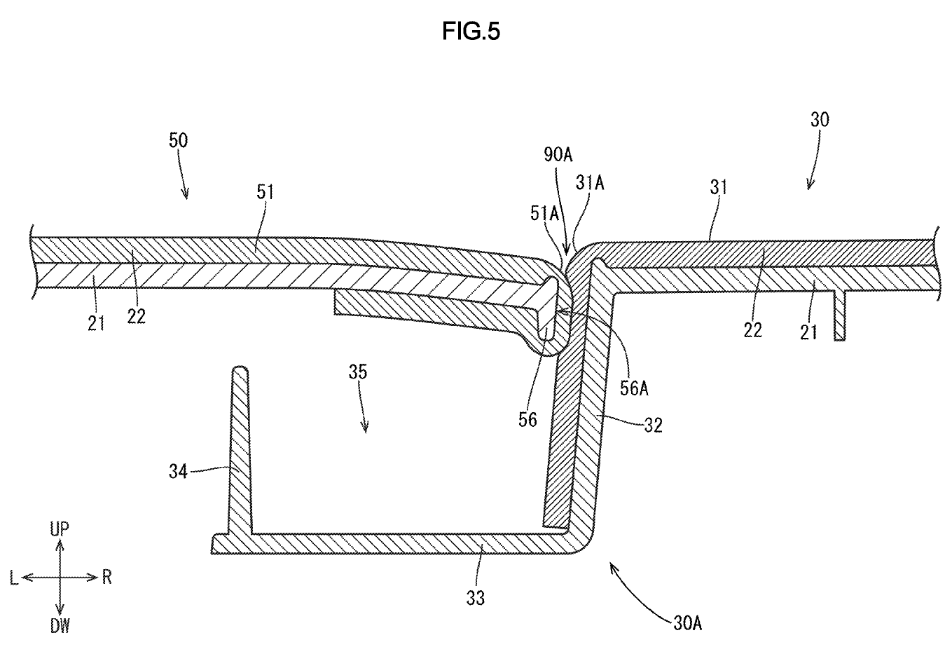

As illustrated in FIGS. 5, 6, 9, and 10, each of the first cover portion 30, the second cover portion 50, the third cover portion 60, and the fourth cover portion 70 includes a base member 21 and a skin 22 that has cushioning properties and covers the surface of the base member 21.

Next, configurations of the first cover portion 30, the second cover portion 50, the third cover portion 60, and the fourth cover portion 70 and a joint structure of the first cover portion 30, the second cover portion 50, the third cover portion 60, and the fourth cover portion 70 will be described in detail. First, the front section 20F of the package tray 20 including the first cover portion 30, the second cover portion 50, and the third cover portion 60 will be described.

### First Cover Portion 30

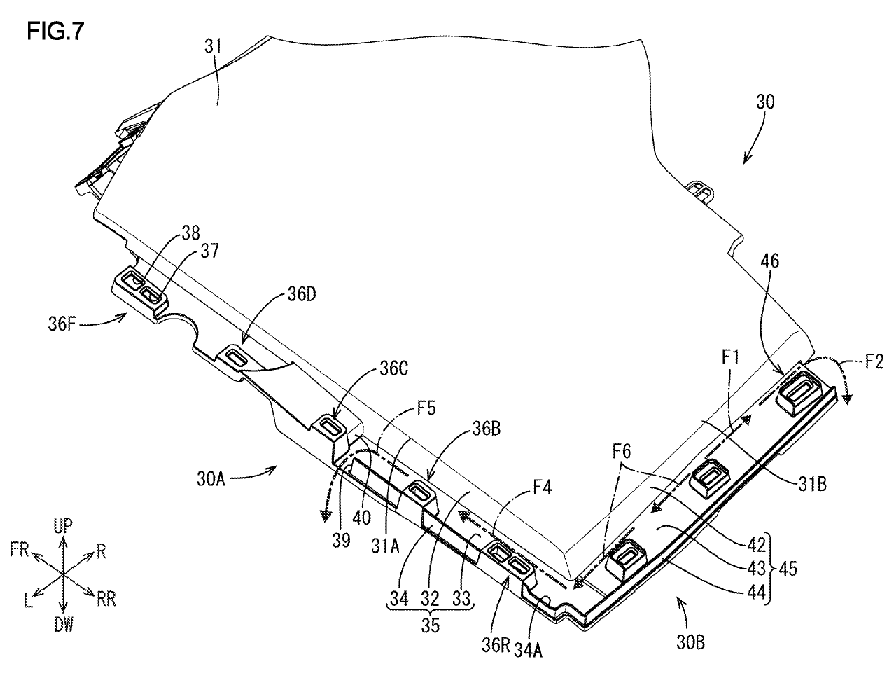

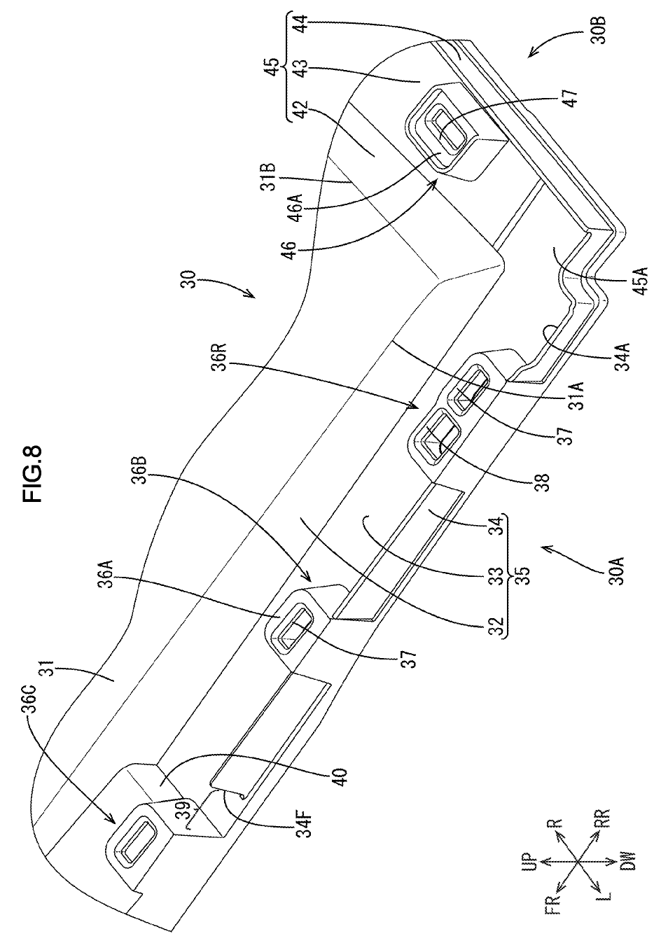

As illustrated in FIGS. 7 and 8, the first cover portion 30 includes a first body portion 31, a first lateral side peripheral portion 30A that is on a side edge 31A (a first side edge) of the first body portion 31, and a first rear side peripheral portion 30B that is on a rear edge 31B (a first rear edge) of the first body portion 31. The first lateral side peripheral portion 30A includes a first lateral side downward extending portion 32 (one example of a downward extending portion), a first lateral side outward extending portion 33 (one example of an outward extending portion), and a first lateral side wall 34 (one example of a wall). The first rear side peripheral portion 30B includes a first rear side downward extending portion 42, a first rear side outward extending portion 43, and a first rear side wall 44. The first body portion 31 has an upper surface that is a portion of a surface (an upper surface) of the front section 20F of the package tray 20. The first body portion 31 has the side edge 31A (a left edge, one example of a first edge) that is disposed adjacent to the second cover portion 50 and the rear edge 31B (the rear edge, one example of the first rear edge) that is disposed adjacent to the fourth cover portion 70. The first lateral side downward extending portion 32 extends downward from the side edge 31A of the first body portion 31. As illustrated in FIG. 5, the first lateral side outward extending portion 33 extends outward from a lower edge of the first lateral side downward extending portion 32. The first lateral side outward extending portion 33 is under the second cover portion 50. The first lateral side downward extending portion 32 and the first lateral side outward extending portion 33 form a L-shaped bent portion. The first rear side downward extending portion 42 extends downward from the rear edge 31B of the first body portion 31. The first rear side outward extending portion 43 extends outward from a lower edge of the first rear side downward extending portion 42. The first rear side outward extending portion 43 is below the fourth cover portion 70. The first rear side downward extending portion 42 and the first rear side outward extending portion 43 form a L-shaped bent portion.

As illustrated in FIGS. 7 and 8, the first lateral side peripheral portion 30A includes the first lateral side wall 34 (one example of a wall) in a rear half portion of the first lateral side peripheral portion 30A. As illustrated in FIG. 5, the first lateral side wall 34 extends upward from an extending end of the first lateral side outward extending portion 33 (an opposite end from the first lateral side downward extending portion 32). The first lateral side wall 34 extends along and opposite the first lateral side downward extending portion 32. The extending length (height) of the first lateral side wall 34 measured from the first lateral side outward extending portion 33 is slightly smaller than the extending length of the first lateral side downward extending portion 32 measured from the first body portion 31. The first lateral side peripheral portion 30A includes a first lateral side recess portion 35 (one example of a recess portion) in the rear half portion of the first lateral side peripheral portion 30A. The first lateral side recess portion 35 is defined by the first lateral side wall 34, the first lateral side outward extending portion 33, and the first lateral side downward extending portion 32. The first lateral side recess portion 35 extends in the vehicular front-rear direction. The first lateral side outward extending portion 33 is configured as a bottom of the first lateral side recess portion 35.

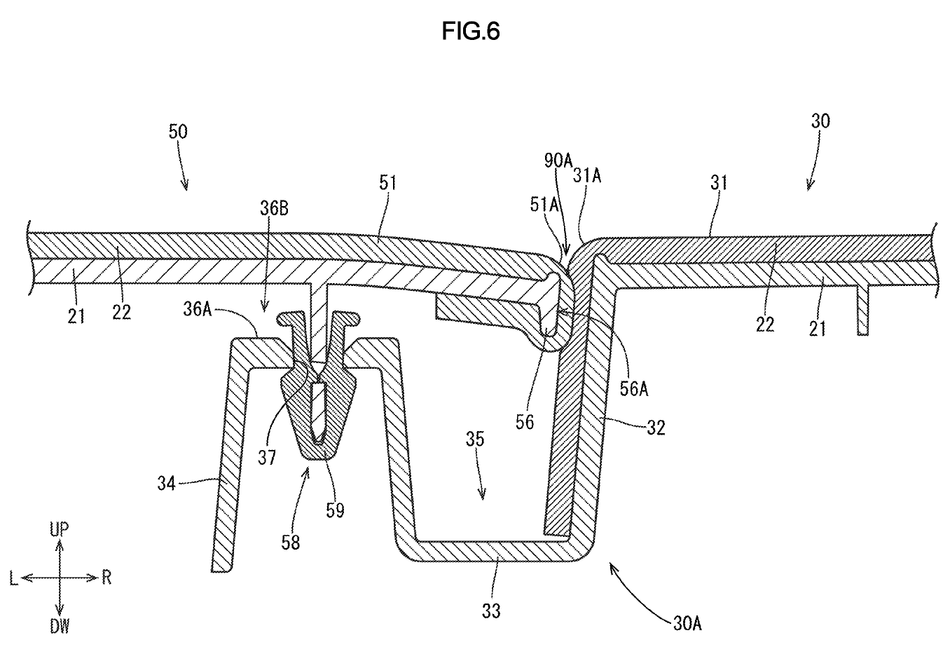

As illustrated in FIG. 7, the first lateral side peripheral portion 30A includes five first lateral side mount seats 36R, 36B, 36C, 36D, 36F (one example of a mount seat) that are arranged at equal intervals in the front-rear direction. The first lateral side mount seats 36R, 36B, 36C, 36D, 36F have a box shape projecting upward from the first lateral side outward extending portion 33. The first lateral side mount seats 36R, 36B, 36C, 36D, 36F have seat surfaces 36A that are upper than upper surface of the first lateral side outward extending portion 33. As illustrated in FIGS. 6 and 7, the first lateral side mount seats 36R, 36B, 36C, 36D, 36F include stopper holes 37 (one example of a stopper portion) in the seat surface 36A, respectively. Stopper pieces 58 of the second cover portion 50 are fitted in the stopper holes 37, respectively. The first lateral side mount seats 36R, 36B, which are on the rear side among the first lateral side mount seats 36R, 36B, 36C, 36D, 36F, are disposed integrally with the first lateral side wall 34 and project inward in the first lateral side recess portion 35. The first lateral side mount seats 36R, 36B are arranged in the front-rear direction. The first lateral side mount seats 36R, 36B, 36C, 36D, 36F, are closer to the extending end (an opposite side from the first lateral side downward extending portion 32) of the first lateral side outward extending portion 33 and away from the first lateral side downward extending portion 32. As illustrated in FIGS. 7 and 8, the first lateral side mount seats 36F, 36R that are on the front side and the rear side among the first lateral side mount seats 36R, 36B, 36C, 36D, 36F include positioning holes 38, respectively. Positioning projections of the second cover portion 50 are fitted in the positioning holes 38, respectively. The positioning hole 38 is disposed next to the stopper hole 37 in the front-rear direction.

As illustrated in FIG. 8, the first lateral side wall 34 extends frontward from a rear end of the first lateral side outward extending portion 33 and ends just before the first lateral side mount seat 36C. The front end 34F of the first lateral side wall 34 is between the first lateral side mount seat 36C and the first lateral side mount seat 36B that are adjacent to each other in the front-rear direction. Namely, a gap 39 (one example of an outlet) is between the front end 34F of the first lateral side wall 34 and the first lateral side mount seat 36C. The gap 39 is in a portion of a recess wall of the first lateral side recess portion 35.

As illustrated in FIGS. 7 and 8, the first lateral side peripheral portion 30A includes a closing portion 40 that projects upward from the first lateral side outward extending portion 33 and has a box shape. The closing portion 40 is continuous to the first lateral side mount seat 36C. The front end of the first lateral side recess portion 35 is closed by the closing portion 40.

The first lateral side outward extending portion 33 slopes downward toward the front side from the rear end thereof with the first cover portion 30 being arranged in a correct position.

With the first cover portion 30 being arranged in the correct position as illustrated in FIG. 3, a front end 19F of the battery 19 is disposed between the first lateral side mount seat 36B and the first lateral side mount seat 36C. The gap 39 of the first lateral side wall 34 is disposed on the front side of the front end 19F of the battery 19. The gap 39 does not overlap the battery 19 in the upper-bottom direction.

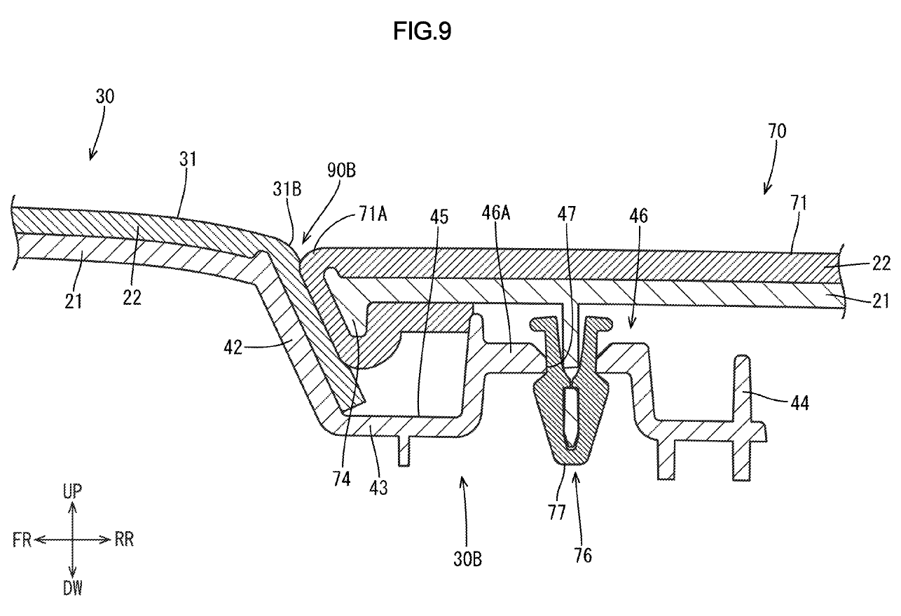

As illustrated in FIGS. 7 and 8, the first rear side peripheral portion 30B includes a first rear side wall 44 that extends upward from an extending end of the first rear side outward extending portion 43 (an opposite end from the first rear side downward extending portion 42). As illustrated in FIG. 9, the extending length (height) of the first rear side wall 44 measured from the first rear side outward extending portion 43 is smaller than the extending length of the first rear side downward extending portion 42 measured from the first body portion 31. The first rear side peripheral portion 30B includes a first rear side recess portion 45. The first rear side recess portion 45 is defined by the first rear side wall 44, the first rear side outward extending portion 43, and the first rear side downward extending portion 42. The first rear side recess portion 45 extends in the vehicular width direction. As illustrated in FIG. 8, the left end portion 45A (a first end portion) of the first rear side recess portion 45 is continuous to the rear end portion of the first lateral side recess portion 35. The right end portion of the first rear side recess portion 45 is open.

The first rear side peripheral portion 30B includes three first rear side mount seats 46 (the mount seat) that are arranged at equal intervals in the vehicular width direction. The first rear side mount seats 46 have a box shape projecting upward from the first rear side outward extending portion 43. The first rear side mount seats 46 have seat surfaces 46A. As illustrated in FIGS. 8 and 9, the first rear side mount seats 46 include stopper holes 47 in the seat surface 46A, respectively. Stopper pieces 76 of the fourth cover portion 70 are fitted in the stopper holes 47, respectively. The first rear side mount seats 46 are spaced from the first rear side downward extending portion 42 and the first rear side wall 44. The first rear side mount seats 46 are arranged in the vehicular width direction. As illustrated in FIG. 9, the first rear side mount seats 46 project from a middle of the first rear side outward extending portion 43 with respect to the width direction of the first rear side outward extending portion 43 (the vehicular front-rear direction).

The first rear side outward extending portion 43 (the first rear side recess portion 45) slopes downward as it extends rightward and leftward from the middle thereof with respect to the vehicular width direction with the first cover portion 30 being arranged in the correct position.

With the first cover portion 30 being arranged in the correct position as illustrated in FIG. 3, a right end of the battery 19 is disposed on the left side of (an inner side with respect to the vehicular width direction) the right end of the first rear side recess portion 45.

### Third Cover Portion 60

The third cover portion 60 has a configuration that is linearly symmetrical with respect to that of the first cover portion 30 and the configuration of the third cover portion will not be described in detail.

### Second Cover Portion 50

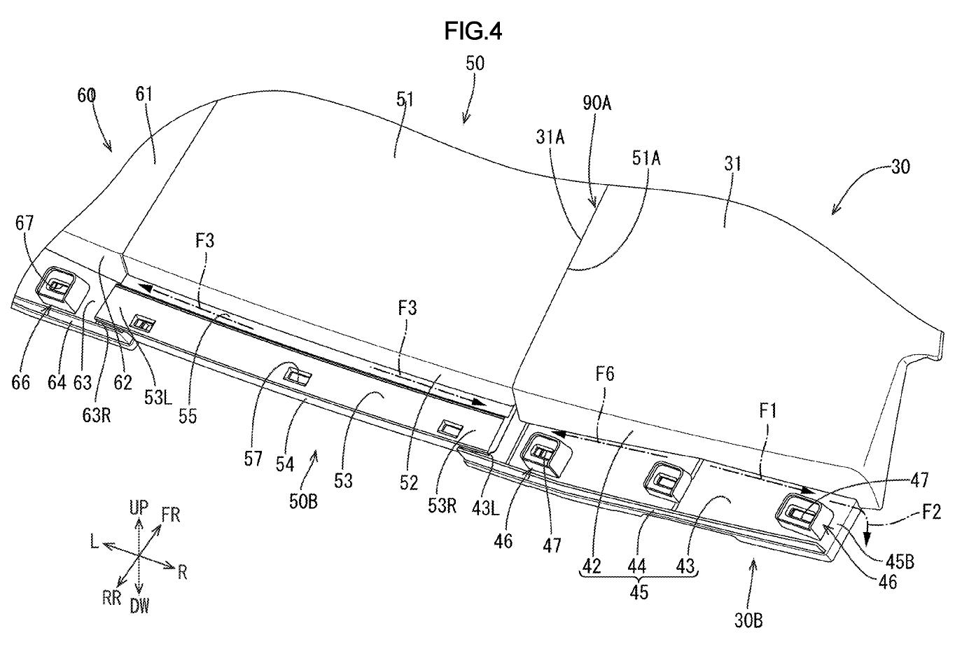

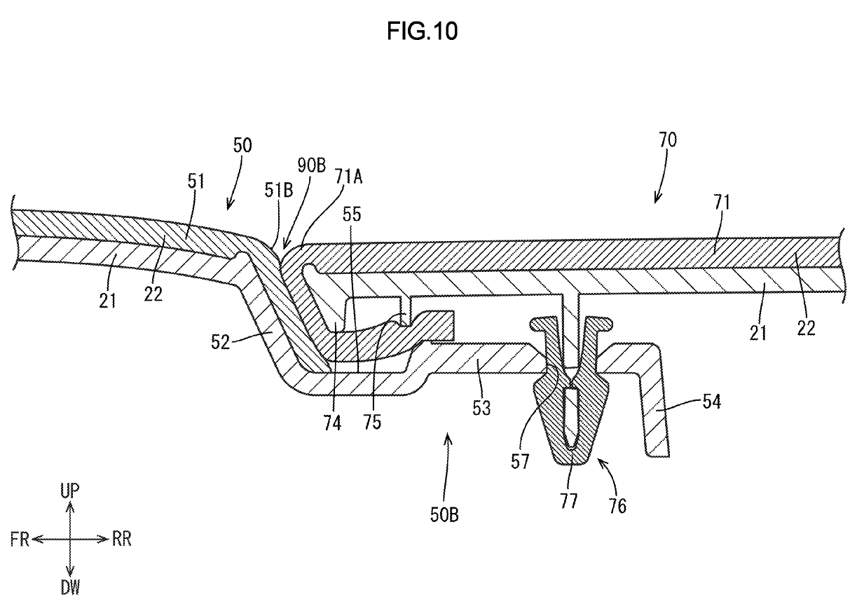

The second cover portion 50 is disposed between the first cover portion 30 and the third cover portion 60. The second cover portion 50 includes a second body portion 51, a right rib 56 (one example of an edge wall portion, refer to FIGS. 5 and 6), a left rib, and a second rear side peripheral portion 50B on a rear edge 51B of the second body portion 51. The second body portion 51 has an upper surface that is a portion of a surface (the upper surface) of the front section 20F of the package tray 20. The second body portion 51 has the side edge 51A (a right edge, one example of a second edge) that is disposed adjacent to the first cover portion 30, a side edge (a left edge) that is adjacent to the third cover portion 60, and the rear edge 51B (a rear edge, one example of a second rear edge) that is disposed adjacent to the fourth cover portion 70. The right rib 56 projects downward from the side edge 51A of the second body portion 51 and extends in the front-rear direction. The left rib projects downward from the left edge and extends in the front-rear direction. The second rear side peripheral portion 50B is on the rear edge 51B (one example of a second rear edge) that is disposed adjacent to the fourth cover portion 70. As illustrated in FIGS. 4 and 10, the second rear side peripheral portion 50B includes a second rear side downward extending portion 52, a second rear side outward extending portion 53, a second rear side wall 54, and a second rear side recess portion 55. The second rear side downward extending portion 52 extends downward from the rear edge 51B of the second body portion 51. The second rear side outward extending portion 53 extends outward from a lower end of the second rear side downward extending portion 52. The second rear side outward extending portion 53 is below the fourth cover portion 70.

As illustrated in FIGS. 4 and 10, the second rear side peripheral portion 50B includes the second rear side recess portion 55 in an extending basal portion of the second rear side outward extending portion 53 (that is adjacent to the second rear side downward extending portion 52). The second rear side recess portion 55 is recessed downward and extends in the vehicular width direction along the rear edge 51B. The second rear side recess portion 55 is shallower than the first rear side recess portion 45. The second rear side recess portion 55 is open at the two ends and slopes downward as it extends from the middle to the two ends. The extending length of the second rear side downward extending portion 52 measured from the second body portion 51 is about half of the extending length of the first rear side downward extending portion 42 measured from the first body portion 31 (refer to FIGS. 9 and 10). With such a configuration, when the first cover portion 30 and the second cover portion 50 are joined together as illustrated in FIG. 4, a right end portion 53R of the second rear side outward extending portion 53 is disposed on and overlaps a left end portion 43L of the first rear side outward extending portion 43. As illustrated in FIG. 8, the first lateral side wall 34 includes a recessed portion 34A that is recessed downward from an upper edge of the first lateral side wall 34. When the first cover portion 30 and the second cover portion 50 are joined together, a portion of the second rear side outward extending portion 53 is disposed on and fitted to the recessed portion 34A. The second rear side recess portion 55 is continuous to the rear end portion of the first lateral side recess portion 35 at a right end portion thereof. A left end portion of the second rear side recess portion 55 is continuous to a rear end portion of a third lateral side recess portion of the third cover portion 60.

With the right end portion 53R of the second rear side outward extending portion 53 overlapping the left end portion 43L of the first rear side outward extending portion 43 as illustrated in FIG. 4, the extending end portion (the end portion opposite from the second rear side downward extending portion 52) of the second rear side outward extending portion 53 is on the front side of the first rear side wall 44 and disposed on the inner side of the first rear side recess portion 45. As illustrated in FIGS. 4 and 10, the second rear side peripheral portion 50B includes the second rear side wall 54 that extends downward from an extending end of the second rear side outward extending portion 53. With the right end portion 53R of the second rear side outward extending portion 53 overlapping the left end portion 43L of the first rear side outward extending portion 43, the second rear side wall 54 extends between the first rear side wall 44 and a third rear side wall 64 of the third cover portion 60 as illustrated in FIG. 4. The space between the first rear side wall 44 and the third rear side wall 64 is closed by the second rear side wall 54. With the second rear side wall 54 extending downward from the second rear side outward extending portion 53, the second rear side outward extending portion 53 is less likely to be deformed even if a force is applied to the second rear side outward extending portion 53 from above at the time of joining the second cover portion 50 and the first and third cover portions 30, 60 together.

As illustrated in FIG. 4, the second rear side outward extending portion 53 includes three stopper holes 57 in which stopper pieces 76 of the fourth cover portion 70 are fitted. The stopper holes 57 are arranged at equal intervals along the vehicular width direction. The stopper holes 57 are at a slightly higher level than the bottom of the second rear side recess portion 55 (refer to FIG. 10) and at a same level as the stopper holes 47, 67 of the first rear side mount seat 46 and a third rear side mount seat 66 (refer to FIG. 4).

As illustrated in FIG. 6, the second cover portion 50 includes the stopper pieces 58 that project downward from the second body portion 51. The stopper pieces 58 correspond to the stopper holes 37 of the first lateral side mount seats 36R, 36B, 36C, 36D, 36F of the first cover portion 30, respectively, with the second cover portion 50 being disposed in a correct position with respect to the first cover portion 30. The stopper piece 58 includes a clip 59 that is elastically deformable. The clip 59 is tapered toward the distal end and elastically deformable in the vehicular width direction. With such a configuration, the clip 59 is inserted in the stopper hole 37 with being elastically deformed and elastically restores its original shape after being inserted to a predefined position. Accordingly, the clip 59 is stopped by a hole edge of the stopper hole 37 from a lower side.

### Joining of First Cover Portion 30 and Second Cover portion 50

With such a configuration, the first cover portion 30 and the second cover portion 50 are joined together by inserting the stopper pieces 58 (the clip 59), which are on the lower surface of the second body portion 51 of the second cover portion 50, in the stopper holes 37, which are in the first lateral side outward extending portion 33 of the first cover portion 30, as illustrated in FIG. 6. In the joined state, a right side surface 56A of the right rib 56 of the second cover portion 50 is contacted with or pressed toward the first lateral side downward extending portion 32 of the first cover portion 30 as illustrated in FIG. 6. As previously described, each of the first cover portion 30 and the second cover portion 50 includes the base member 21 that is covered by the skin 22 having cushioning properties. Therefore, the cushioning skin 22 of the first cover portion 30 and the cushioning skin 22 of the second cover portion 50 are contacted with each other with being pressed and a space is less likely to be created at a border 90A of the first cover portion 30 and the second cover portion 50. The border 90A of the first cover portion 30 and the second cover portion 50 is defined by the side edge 31A of the first body portion 31 and the side edge 51A of the second body portion 51.

With the first cover portion 30 and the second cover portion 50 being joined together, the first lateral side recess portion 35 that extends in the front-rear direction is below the side edge 51A of the second cover portion 50 (the border 90A of the first cover portion 30 and the second cover portion 50) as illustrated in FIGS. 5 and 6. The right rib 56 of the second cover portion 50 projects toward an inner space of the first lateral side recess portion 35. Therefore, even if liquid infiltrates via the border 90A of the first cover portion 30 and the second cover portion 50, the liquid falls along the right rib 56 and drops into the first lateral side recess portion 35 and further flows frontward along the bottom (the first lateral side outward extending portion 33) of the first lateral side recess portion 35, which slopes downward as it extends frontward, and drops down through the gap 39. Since the battery 19 is not disposed under the gap 39, the battery 19 is less likely to get wet with the liquid.

With the first cover portion 30 and the second cover portion 50 being joined together, the first rear side downward extending portion 42 and the second rear side downward extending portion 52 are continuous to each other and on a same plane as illustrated in FIG. 4. With the first cover portion 30 and the second cover portion 50 being joined together, the right end portion 53R of the second rear side outward extending portion 53 is disposed on an upper side of the left end portion 43L of the first rear side outward extending portion 43. The right end portion 53R of the second rear side outward extending portion 53 overlaps the left end portion 43L of the first rear side outward extending portion 43.

As illustrated in FIG. 1, a roof side trim 80 is disposed to extend along the opening edge of the rear opening 12 of the vehicle 10 and includes an opening side recess portion 81 that is recessed downward. With the first cover portion 30 being arranged in a correct position, the right end of the first rear side recess portion 45, which is open, overlaps and is above the opening side recess portion 81. The right end portion 45B (a second end portion, refer to FIG. 4) of the first rear side recess portion 45 is continuous to the opening side recess portion 81.

The structure of joining the second cover portion 50 and the third cover portion 60 is similar to that of the second cover portion 50 and the first cover portion 30. The first cover portion 30 and the third cover portion 60 are disposed in a predefined position and the second cover portion 50 is fitted to the first cover portion 30 and the third cover portion 60 and the front section 20F of the package tray 20 is obtained.

### Fourth Cover Portion 70

The fourth cover portion 70 (one example of a rear cover portion) that is configured as the rear section 20R of the package tray 20 is disposed on the rear side of the first cover portion 30, the second cover portion 50, and the third cover portion 60 (the front section 20F of the package tray 20), which are arranged in the vehicular width direction. The fourth cover portion 70 extends from the first cover portion 30 to the third cover portion 60. As illustrated in FIG. 2, the fourth cover portion 70 includes a fourth front body portion 71 (one example of a rear body portion) and a fourth rear body portion 72. The fourth front body portion 71 is a front section of the fourth cover portion 70 and is a plate member having plate surfaces facing upward and downward. The fourth rear body portion 72 is has a slope surface that slopes obliquely downward from the fourth front body portion 71. As illustrated in FIGS. 1 and 3, the fourth cover portion 70 includes side wall portions 73 at a right end and a left end thereof and both side ends of the fourth cover portion 70 are closed.

As illustrated in FIGS. 9 and 10, the fourth cover portion 70 includes a front rib 74 that projects downward from a front edge 71A of the fourth front body portion 71. The first rear side downward extending portion 42, the second rear side downward extending portion 52, and a third rear side downward extending portion 62 of the third cover portion 60 extend downward and rearward in an oblique direction from the first body portion 31, the second body portion 51, and a third body portion 61 of the third cover portion 60, respectively. The front rib 74 of the fourth cover portion 70 has a front surface (a side surface of the front rib 74) that is a slope extending along the first rear side downward extending portion 42, the second rear side downward extending portion 52, and the third rear side downward extending portion 62.

As illustrated in FIG. 10, the fourth cover portion 70 includes a holding rib 75 that projects downward in a vertical direction from the fourth front body portion 71. The holding rib 75 is on the rear side of the middle portion of the front rib 74 with respect to the vehicular width direction. The middle portion of the front rib 74 is disposed behind the second cover portion 50. The holding rib 75 extends in the vehicular width direction along the front rib 74. The skin 22 is folded back at the front edge 71A of the fourth cover portion 70. A middle portion of the end portion of the folded skin 22 that is disposed behind the second cover portion 50 is sandwiched and held by the second rear side outward extending portion 53 and the holding rib 75 (refer to FIG. 10).

As previously described, the right end portion 53R and the left end portion 53L of the second rear side outward extending portion 53 overlaps and are on an upper side of the left end portion 43L of the first rear side outward extending portion 43 and the right end portion 63R of the third rear side outward extending portion 63, respectively. Therefore, the second rear side outward extending portion 53 is at a higher level than the first rear side outward extending portion 43 and the third rear side outward extending portion 63. Accordingly, the depth of the second rear side recess portion 55 of the second rear side outward extending portion 53 is limited and is relatively small as illustrated in FIG. 10. Therefore, if liquid infiltrates into the second rear side recess portion 55, the second rear side recess portion 55, which is relatively shallow, may overflow and the liquid may leak from a rear edge side of the second cover portion 50. However, in this embodiment, the end portion of the skin 22 of the fourth cover portion 70 is sandwiched and held by the second rear side outward extending portion 53 and the holding rib 75 of the second cover portion 50. Therefore, the liquid in the second rear side recess portion 55 is less likely to leak toward the rear side due to a double sealing structure of the sealing structure with the holding rib 75 and a sealing structure at a border 90B of the second body portion 51 and the fourth front body portion 71. The border 90B of the front section 20F and the rear section 20R is defined by the front edge 71A of the fourth cover portion 70, the rear edge 31B of the first body portion 31, the rear edge 51B of the second body portion 51, and a rear edge of the third body portion 61.

As illustrated in FIGS. 9 and 10, the fourth cover portion 70 includes the stopper pieces 76 that project downward from the fourth front body portion 71. The stopper pieces 76 correspond to the stopper holes 47, 57, 67 of the rear side outward extending portions 43, 53, 63 of the first cover portion 30, the second cover portion 50, the third cover portion 60, respectively. The stopper piece 76 includes a clip 77 that is elastically deformable. The clip 77 is tapered toward the distal end (a lower end) and elastically deformable in the vehicular front-rear direction. With such a configuration, the clips 77 are inserted in the stopper holes 47, 57, 67 with being elastically deformed and elastically restore their original shape after being inserted to a predefined position. Accordingly, the clips 77 are stopped by hole edges of the stopper holes 47, 57, 67 from a lower side.

### Joining of Front section 20F and Fourth Cover Portion 70

The front section 20F and the fourth cover portion 70 (the rear section 20R) of the package tray 20 are joined together by inserting the stopper pieces 76 (the clips 77) on the lower surface of the fourth front body portion 71 of the fourth cover portion 70 in the corresponding stopper holes 47, 57, 67 of the rear side outward extending portions 43, 53, 63 of the front section 20F, respectively, as illustrated in FIGS. 9 and 10. In such a joined state, the front surface of the front rib 74 (the side surface of the front rib 74) of the fourth cover portion 70 is contacted with or pressed toward the rear side downward extending portions 42, 52, 62. As previously described, each of the first cover portion 30, the second cover portion 50, the third cover portion 60, and the fourth cover portion 70 includes the base member 21 that is covered by the skin 22 having cushioning properties. Therefore, the cushioning skins 22 of the cover portions are contacted with each other with being pressed and a gap is less likely to be created at the border 90B of the front section 20F and the fourth cover portion 70 (the rear section 20R).

With the front section 20F and the fourth cover portion 70 (the rear section 20R) being joined together, the first rear side recess portion 45, the second rear side recess portion 55, and the third rear side recess portion 65 that extend in the vehicular width direction are under the front edge 71A of the fourth cover portion 70 (the border 90B of the front section 20F and the rear section 20R) as illustrated in FIGS. 9 and 10. The front rib 74 of the fourth cover portion 70 projects toward an inner space of the first rear side recess portion 45, the second rear side recess portion 55, and the third rear side recess portion 65. Therefore, even if liquid infiltrates via the border 90B of the front section 20F and the fourth cover portion 70 (the rear section 20R), the liquid flows along the front rib 74 and drops into the first rear side recess portion 45, the second rear side recess portion 55, and the third rear side recess portion 65.

Liquid that drops in a rear side recess portion 105 (refer to FIG. 3) that includes the first rear side recess portion 45, the second rear side recess portion 55, and the third rear side recess portion 65 exits the package tray 20 and eventually the vehicle 10 as follows. Liquid that drops in right and left end portions of the rear side recess portion 105 exits the package tray 20 as follows. Specifically, the flow of the liquid that drops in the right end portion of the first rear side recess portion 45 will be described with reference to FIGS. 4 and 7. The liquid dropping in the right end portion of the first rear side recess portion 45 (the left end portion of the third rear side recess portion 65) flows along the slope of the first rear side recess portion 45 (the third rear side recess portion 65) to the right end portion (the left end portion) of the front section 20F with respect to the vehicular width direction as illustrated with the arrow F1 in FIGS. 4 and 7. Then, as illustrated with the arrow F2 in FIGS. 4 and 7, the liquid drops from the right end portion (the left end portion) of the front section 20F to the opening side recess portion 81 and flows along the opening side recess portion 81 through a predetermined portion. The liquid dropping in the middle portion of the rear side recess portion 105 (the second rear side recess portion 55) with respect to the vehicular width direction flows to the end portions 53R, 53L side of the second rear side recess portion 55 as illustrated with the arrows F3 in FIG. 4. The liquid further flows down from the two end portions of the second rear side recess portion 55 to the first lateral side recess portion 35 and a third lateral side recess portion of the third cover portion 60, which overlap and are below the second rear side recess portion 55, and further flows along the first lateral side outward extending portion 33 and a third lateral side outward extending portion of the third cover portion 60 (bottom portions) and drops down through the gap 39 as illustrated with the arrows F4 and F5 in FIG. 7. The liquid dropping in the portion of the rear side recess portion 105 between the middle portion (the second rear side recess portion 55) and each of the right and left end portions of the rear side recess portion 105 flows as follows. The liquid dropping in the portion of the first rear side recess portion 45 (the portion of the third rear side recess portion 65) close to the second rear side recess portion 55 flows along the slope of the first rear side recess portion 45 (the third rear side recess portion 65) to the first lateral side recess portion 35 as illustrated with the arrow F6 in FIGS. 4 and 7 and further flows frontward along the first lateral side outward extending portion 33 (a third lateral side outward extending portion of the third cover portion 60) and drops down through the gap 39 as illustrated with the arrows F4 and F5 in FIG. 7. Since the battery 19 is not disposed below the gap 39, the battery 19 is less likely to get wet with the liquid.

Next, operations and effects of this embodiment will be described. The package tray 20 of this embodiment has a plate surface facing upward and covers the battery 19 from above. The package tray 20 includes the first cover portion 30 and the second cover portion 50. The first cover portion 30 includes the first body portion 31 having a surface that is configured as a portion of the surface of the package tray 20. The second cover portion 50 includes the second body portion 51 having a surface that is configured as a portion of the surface of the package tray 20. The first cover portion 30 and the second cover portion 50 are arranged such that the first body portion 31 and the second body portion 51 are continuous to each other with having the border 90A therebetween. The border 90A of the first body portion 31 and the second body portion 51 overlaps the battery 19. The first body portion 31 includes the side edge 31A that is adjacent to the second body portion 51. The first cover portion 30 includes the first lateral side downward extending portion 32 that extends downward from the side edge 31A, the first lateral side outward extending portion 33 that extends outward from an extending end of the first lateral side downward extending portion 32 with being bent and is disposed below the second body portion 51, and the first lateral side wall 34 that extends upward from an extending end of the first lateral side outward extending portion 33 and along the first lateral side downward extending portion 32. The first cover portion 30 includes the first lateral side recess portion 35 that is defined by the first lateral side downward extending portion 32, the first lateral side outward extending portion 33, and the first lateral side wall 34. The first lateral side recess portion 35 includes the gap 39 that is disposed not to overlap the battery 19. Liquid that infiltrates into the first lateral side recess portion 35 via the border 90A between the first body portion 31 and the second body portion 51 exits through the gap 39 such that the liquid does not drop on the battery 19.

According to the above configuration, the first lateral side recess portion 35 is disposed below the border 90A. Therefore, even if liquid infiltrates via the border 90A of the first body portion 31 and the second body portion 51, the liquid flows along the first lateral side recess portion 35 and exits through the gap 39 that does not overlap the battery 19. Thus, the liquid that infiltrates via the border 90A is less likely to directly drop on the battery 19. Furthermore, with such a first lateral side recess portion 35, a waterproof sealing member and a waterproof guard member or the waterproofing of the battery 19, which have been necessary, are not necessary and this reduces a manufacturing cost.

The package tray 20 includes the first lateral side peripheral portion 30A that is on the side edge 31A of the first body portion 31. The first lateral side peripheral portion 30A includes the first lateral side mount seats 36R, 36B, 36C, 36D, 36F that project upward from the first lateral side outward extending portion 33 and are spaced from the first lateral side downward extending portion 32. The first lateral side mount seats 36R, 36B, 36C, 36D, 36F have the seat surfaces 36A that are at a higher level than the first lateral side outward extending portion 33. With the stopper pieces 58 of the second body portion 51 being fitted in the stopper holes 37 of the seat surfaces 36A, respectively, the second cover portion 50 is fixed to the first cover portion 30.

According to the above configuration, the second cover portion 50 is easily mounted on the first cover portion 30 and the first cover portion 30 and the second cover portion 50 are stably in the joined state in which the first cover portion 30 and the second cover portion 50 are arranged next to each other. Since the first lateral side mount seats 36R, 36B, 36C, 36D, 36F are spaced from the first lateral side downward extending portion 32, liquid that may infiltrate via the border 90A of the first body portion 31 and the second body portion 51 flows down in the first lateral side recess portion 35 without being obstructed by the first lateral side mount seats 36R, 36B, 36C, 36D, 36. Since the stopper hole 37 of the seat surface 36A is upper than the bottom of the first lateral side recess portion 35 (the first lateral side outward extending portion 33), the liquid that infiltrates in the first lateral side recess portion 35 is less likely to flow down through the stopper hole 37. Therefore, the stopper holes 37 (the stopper portion) can be formed in any desired portions in the first lateral side recess portion 35.

The first lateral side outward extending portion 33 is a slope that extends downward toward the gap 39 in the extending direction in which the first lateral side recess portion 35. With such a configuration, the liquid that infiltrates into the first lateral side recess portion 35 is likely to flow toward the gap 39.

The second cover portion 50 includes the right rib 56 at the side edge 51A of the second body portion 51 that is next to the first body portion 31. The right rib 56 projects downward from the side edge 51A of the second body portion 51. With such a configuration, the liquid that infiltrates via the border 90A of the first body portion 31 and the second body portion 51 surely flows along the right rib 56 into the first lateral side recess portion 35. Therefore, the liquid is less likely to flow along the lower surface of the second cover portion 50 (the second body portion 51) and drop on the battery 19 that is disposed under the package tray 20.

The package tray 20 is disposed between the seat back 13 of the vehicle 10 and the luggage compartment 14 in the rear section of the vehicle 10. The package tray 20 covers the battery 19 that is disposed upper (higher) than the deck board 17 that is configured as the floor surface of the luggage compartment 14.

The package tray 20 further includes the fourth cover portion 70 that is on the rear side of the first cover portion 30. The fourth cover portion 70 includes the fourth front body portion 71 having a surface that is configured as a portion of the surface of the package tray 20. The fourth cover portion 70 and the first cover portion 30 are arranged such that the fourth front body portion 71 and the first body portion 31 are continuous to each other with having the border 90B therebetween. The first body portion 31 includes the rear edge 31B that is adjacent to the fourth front body portion 71. The first cover portion 30 includes the first rear side downward extending portion 42 that extends downward from the rear edge 31B, the first rear side outward extending portion 43 that extends outward from an extending end of the first rear side downward extending portion 42 with being bent and is disposed below the fourth front body portion 71, and the first rear side wall 44 that extends upward from an extending end of the first rear side outward extending portion 43 and along the first rear side downward extending portion 42. The first cover portion 30 includes the first rear side recess portion 45 that is defined by the first rear side downward extending portion 42, the first rear side outward extending portion 43, and the first rear side wall 44. As illustrated in FIGS. 7 and 8, the left end portion 45A of the first rear side recess portion 45 is continuous to the first lateral side recess portion 35, which is disposed corresponding to the border 90A of the first cover portion 30 and the second cover portion 50 arranged next to each other in the vehicular width direction.

According to the above configuration, at least a part of the liquid that infiltrates via the border 90B between the first body portion 31 and the fourth front body portion 71 exits through the gap 39 with using the first lateral side recess portion 35 that is disposed corresponding to the border 90A between the first cover portion 30 and the second cover portion 50.

The right end portion 45B of the first rear side recess portion 45 is continuous to the opening side recess portion 81 that is recessed downward and extends along the opening edge of the rear opening 12 of the vehicle 10. The luggage compartment 14 of the vehicle accessible through the rear opening 12.

According to the above configuration, at least a part of the liquid that infiltrates via the border 90B between the first body portion 31 and the fourth front body portion 71 exits through the predetermined portion of the package tray 20 with using the opening side recess portion 81 that is continuous to the first rear side recess portion 45.

The package tray 20 includes the base member 21 and the skin 22 that covers the surface of the base member 21. The fourth cover portion 70 extends from the first cover portion 30 to the second cover portion 50 that is arranged next to the first cover portion 30 in the vehicular width direction. The second cover portion 50 includes the second rear side downward extending portion 52 that extends downward from the rear edge 51B that is next to the fourth front body portion 71, the second rear side outward extending portion 53 that extends outward from an extending end of the second rear side downward extending portion 52 with being bent and is disposed below the fourth front body portion 71, and the second rear side recess portion 55 that is recessed downward in the extending basal portion of the second rear side outward extending portion 53 (close to the second rear side downward extending portion 52) and extends along the rear edge 51B. The fourth cover portion 70 includes the holding rib 75 that projects downward from the lower surface of the fourth front body portion 71. The skin 22 that is folded back at the front edge 71A of the fourth front body portion 71 is sandwiched and held by the second rear side outward extending portion 53 and the holding rib 75.

The second cover portion 50 is disposed to overlap the first lateral side outward extending portion 33 at the side edge 31A of the first body portion 31 from above and thus, the stopper pieces 58 are fitted to the stopper holes 37. Therefore, the extending length of the second rear side downward extending portion 52 measured from the second body portion 51 is smaller than the extending length of the first rear side downward extending portion 42 measured from the first body portion 31. The depth dimension of the second rear side recess portion 55 is smaller than the depth dimension of the first rear side recess portion 45. The liquid that infiltrates in the second rear side recess portion 55 may flow out of the second rear side recess portion 55.

In this respect, according to the above configuration, the second rear side recess portion 55 is sealed at two portions. The second rear side recess portion 55 is sealed with sealing at the border 90B of the second body portion 51 and the fourth front body portion 71 and sealing with the second rear side outward extending portion 53 and the holding rib 75. Therefore, the second rear side recess portion 55 is less likely to overflow with the liquid.

The fourth rear body portion 72 of the fourth cover portion 70 extends downward as it extends from the fourth front body portion 71.

### Other Embodiments

The present disclosure is not limited to the embodiment described above and illustrated in the drawings. The following embodiments may be included in the technical scope of the technology described herein.

(1) In the embodiment, the package tray 20 includes the front section 20F, which includes the first cover portion 30, the second cover portion 50, and the third cover portion 60, and the rear section 20R, which includes the fourth cover portion 70; however, the number and the arrangement of the cover portions may be altered. For instance, the cover portions may be arranged only in the vehicular width direction or may be arranged only in the vehicular front-rear direction.

(2) In the embodiment, the gap 39 that is between the front end 34F of the first lateral side wall 34 and the first lateral side mount seat 36C is configured as the outlet and the gap 39 is in a portion of the first lateral side recess portion 35; however, the configuration of the outlet may be altered. For instance, a hole formed in an outward extending portion (a bottom of a recess) may be configured as the outlet or an end of an open recess may be configured as the outlet.

(3) In the embodiment, the bottom of the recess portion (the first lateral side outward extending portion 33, the first rear side outward extending portion 43) is a slope that extends downward toward the outlet (the gap 39, the right end portion); however, the bottom of the recess portion may not be a slope.

(4) The package tray 20 may not include the right rib 56, the left rib, and the front rib 74.

(5) The package tray 20 may not include the skin 22.

(6) In the embodiment, the package tray 20 is described as an example of the vehicular cover member. However, the technology described herein may be applied to a deck board, a floor of a passengers’ compartment, and any other vehicular cover members.

1. A vehicular cover member covering an object from above, the vehicular cover member comprising:
a first cover portion including
a first body portion that has a plate shape and a first side edge,
a downward extending portion that extends downward from the first side edge,
an outward extending portion that extends outward from an extending end of the downward extending portion,
a wall that extends upward from an extending end of the outward extending portion and extends along and opposite the downward extending portion, and
a recess portion that is defined by the downward extending portion, the outward extending portion, and the wall, the recess portion including an outlet so as not to overlap the object; and
a second cover portion including a second body portion that has a plate shape and a second side edge, the second cover portion being disposed next to the first cover portion such that the first body portion is continuous to the second body portion and overlapping the outward extending portion of the first cover portion from above, wherein
a border of the first body portion and the second body portion defined by the first side edge and the second side edge overlaps the object.

2. The vehicular cover member according to claim 1, wherein
the first cover portion further includes a mount seat that projects upward from the outward extending portion and is spaced from the downward extending portion,
the mount seat has a seat surface that is upper than the outward extending portion and has a stopper portion, and
the second cover portion includes a stopper piece on the second body portion and is fixed to the first cover portion with the stopper piece being fitted to the stopper portion.

3. The vehicular cover member according to claim 1, wherein the outward extending portion is inclined downward as it extends toward the outlet along the recess portion.

4. The vehicular cover member according to claim 1, wherein the second cover portion includes an edge wall portion that extends downward at the second edge of the second body portion.

5. The vehicular cover member according to claim 1, wherein the vehicular cover member is a package tray that is disposed between a seat back of a vehicle and a luggage compartment in a rear section of the vehicle and is disposed upper than a deck board that is configured as a floor surface of the luggage compartment.

6. The vehicular cover member according to claim 1, further comprising:
a rear cover portion disposed on a rear side of the first cover portion and including a rear body portion that has a plate shape and a front edge and is disposed next to the first body portion such that a rear border of the first body portion and the rear body portion is defined by the front edge and a first rear edge of the first body portion, wherein
the first cover portion further includes
a first rear side downward extending portion that extends downward from the first rear edge,
a first rear side outward extending portion that extends outward from an extending end of the first rear side downward extending portion and is disposed to overlap and under the rear body portion,
a first rear side wall that extends upward from an extending end of the first rear side outward extending portion and extends along and opposite the first rear side downward extending portion, and
a first rear side recess portion that is defined by the first rear side downward extending portion, the first rear side outward extending portion, and the first rear side wall, the first rear side recess portion including a first end portion that is continuous to the recess portion that is disposed corresponding to the border of the first cover portion and the second cover portion that are arranged in a vehicular width direction.

7. The vehicular cover member according to claim 1, further comprising:
a rear cover portion disposed on a rear side of the first cover portion and including a rear body portion that has a plate shape and a front edge and is disposed next to the first body portion such that a rear border of the first body portion and the rear body portion is defined by the front edge and a first rear edge of the first body portion, wherein
the first cover portion further includes
a first rear side downward extending portion that extends downward from the first rear edge,
a first rear side outward extending portion that extends outward from an extending end of the first rear side downward extending portion and is disposed to overlap and under the rear body portion,
a first rear side wall that extends upward from an extending end of the first rear side outward extending portion and extends along and opposite the first rear side downward extending portion, and
a first rear side recess portion that is defined by the first rear side downward extending portion, the first rear side outward extending portion, and the first rear side wall, and
the first rear side recess portion includes a second end portion that is continuous to an opening side recess portion that is recessed downward and extends along an opening edge of a vehicular rear opening through which a luggage compartment is accessible.

8. The vehicular storage cover member according to claim 6, wherein
each of the first cover portion, the second cover portion, and the rear cover portion includes a base member having a first surface and a second surface that is an opposite surface of the first surface and a skin that covers the first surface of the base member,
the skin is folded to the second surface of the base member at the front edge of the rear body portion and a folded skin is disposed on the front edge,
the rear cover portion is disposed to extend from the first cover portion to the second cover portion in the vehicular width direction,
the second body portion has a second rear edge that is next to the front edge of the rear body portion and includes
a second rear side downward extending portion that extends downward from the second rear edge,
a second rear side outward extending portion that extends outward from an extending end of the second rear side downward extending portion and is disposed to overlap and under the rear body portion, and
a second rear side recess portion that is recessed downward in an extending basal portion of the second rear side outward extending portion and extends along the second rear edge, and
the rear cover portion includes a holding rib that projects downward from the second surface of the base member of the rear body portion and the folded skin is held by the holding rib and the second rear side outward extending portion.

9. The vehicular storage cover member according to claim 6, wherein the rear cover portion includes a front section and a rear section that extends downward from the front section.

10. The vehicular cover member according to claim 4, wherein the edge wall portion projects downward from the second side edge of the second body portion and is contacted with the downward extending portion near the first side edge.

11. The vehicular cover member according to claim 6, wherein
the rear cover portion is disposed to extend from the first cover portion to the second cover portion in the vehicular width direction,
the second body portion has a second rear edge that is next to the front edge of the rear body portion and includes
a second rear side downward extending portion that extends downward from the second rear edge,
a second rear side outward extending portion that extends outward from an extending end of the second rear side downward extending portion and is disposed to overlap and under the rear body portion, and
a second rear side recess portion that is recessed downward in an extending basal portion of the second rear side outward extending portion and extends along the second rear edge and the second rear side recess portion is continuous to the recess portion.

12. The vehicular cover member according to claim 11, wherein the second rear side recess portion is shallower than the first rear side recess portion.

13. The vehicular cover member according to claim 11, wherein
the first rear side recess portion slopes downward as it extends from a middle portion to the first end portion, and
the second rear side recess portion slopes downward as it extends from a middle portion to an end portion that is continuous to the recess portion.
